(19) United States
(12) Patent Application Publication
(10) Pub. No.: US 2025/0307640 A1
(43) Pub. Date: Oct. 2, 2025

(54) Automated AI-Based Handling of Requests for Privileges Escalation

(71) Applicant: VARONIS SYSTEMS, INC., New York, NY (US)

(72) Inventors: Amir Belgi, Ra’anana (IL); Ron Sneh, Atlit (IL); Ori Katz, Kiryat Ono (IL)

(21) Appl. No.: 18/622,949

(22) Filed: Mar. 31, 2024

(51) Int. Cl. G06N 3/0895

(52) U.S. Cl. CPC G06N 3/0895

(57) ABSTRACT

A system automatically evaluates requests for escalation of privileges in an organization. The system receives a Request for Escalation of Privileges (REP), in a natural language, that indicates a request from a Requesting User to elevate access privileges to a computerized organizational resource. The system automatically feeds the REP as input into a fine-tuned Large Language Model (LLM), which automatically performs an analysis of that REP, and automatically generates an LLM-based output indicating at least: a proposed minimal set of elevated permissions that are estimated by the LLM to be needed and also sufficient for achieving a task described in the REP. The LLM is configured to further generate output with textual reasoning for inclusion of at least one elevated permission in that proposed minimal set of elevated permissions.

### FIELD

Some embodiments are related to the field of computerized systems.

### BACKGROUND

A large corporation, organization, or other entity may have thousands of team-members who utilize computing devices for various purposes; for example, to send and receive electronic mail, to engage in video calls, to browse the Internet, to compose documents, to access data repositories, to prepare presentations, to manage projects, or the like.

An end-user of an electronic device, and particularly a network administrator, may receive hundreds of incoming messages per day, from numerous recipients, with regard to a variety of topics.

### SUMMARY

Some embodiments include systems, devices, and methods for automated handling and management of incoming requests for escalation of privileges, particularly by utilizing one or more Large Language Models (LLMs) that operate innovatively with a suitable context

For example, a system automatically evaluates requests for escalation of privileges in an organization. The system receives a Request for Escalation of Privileges (REP), in a natural language, that indicates a request from a Requesting User to elevate access privileges to a computerized organizational resource. The system automatically feeds the REP as input into a fine-tuned Large Language Model (LLM), which automatically performs an analysis of that REP, and automatically generates an LLM-based output indicating at least: a proposed minimal set of elevated permissions that are estimated by the LLM to be needed and also sufficient for achieving a task described in the REP. The LLM is configured to further generate output with textual reasoning for inclusion of at least one elevated permission in that proposed minimal set of elevated permissions.

Some embodiments may provide other and/or additional benefits and/or advantages.

### BRIEF DESCRIPTION OF THE DRAWINGS

FIG. 1 is a schematic block-diagram illustration of a system, in accordance with some demonstrative embodiments.

FIG. 2 is a schematic block-diagram illustration of a system, in accordance with some demonstrative embodiments.

### DETAILED DESCRIPTION OF SOME DEMONSTRATIVE EMBODIMENTS

The Applicant has realized that a user in an organization regularly has particular privileges for accessing or utilizing, or making changes to, particular organizational resources. For example, realized the Applicant, User Adam may be a junior customer support person and may only have permission to read from Repository A, and not to write into it; whereas User Bob may be a senior technical support person and may further have permission to modify existing records in Repository A; whereas User Carl may be a senior database administrator and may further have permission to create new records and to create new tables or new databases. Similarly, User Adam may not have any access to Repository B, whereas User Bob may have read-only access to Repository B, and whereas User Carl may have read-and-write access to Repository B.

Similar access control and differential privileges, realized the Applicant, may be defined or configured with regard to other types of organizational resources, including (as non-limiting examples) data repositories, databases, web servers, email servers, application servers, back-end servers, front-end servers, development servers, production servers, testing equipment, Quality Control (QC)/Quality Assurance (QA) servers, particular files, particular documents, particular folders or disks, virtual machine (VM) units, virtualized instances and entities, and other organizational resources, which may be implemented locally or on-premises (e.g., using a computer server that is located physically in an organization's office) and/or remotely and/or as a cloud-computing implementation or utilizing one or more Cloud Service Providers (CSPs).

In another demonstrative example, User David and User Ellen may have different access privileges and different operational privileges with regard to the same CSP resource or server or repository; for example, only one of these two users (and not the other user) may regularly have sufficient privileges to create or span a new process or instance of an application or a Virtual Machine (VM), or to pause or stop or delete or discard an existing process or instance or VM, or to restart or reboot a physical server or a VM, or to change a particular operational parameter or configuration of a particular server or VM, or to purge or discard or delete a particular queue or data-item, or to copy an entire database or table or folder, or to delete a particular CSP-located file or folder or database record or database table, or to create a new database record or a new database table, or the like.

The Applicant has further realized that it is common and appropriate to assign different privileges to different users, based on their particular role in the organization and/or based on their level of knowledge or expertise, and/or in accordance with the Principle of Least Privilege (PoLP) which is a security-related practice that limits a user's privileges (e.g., access permission, read permissions, write permissions, delete permissions, copy permissions, or the like) to the minimum level of authorizations and resources that such user needs in order to achieve a particular goal or in order to complete a particular task.

The Applicant has further realized that in some situations, a particular user may need a temporary modification of his privileges; for example, in order to resolve or cure or mitigate a problem, or in order to address a customer's request, or the like. Such team-member, realized the Applicant, may utilize an Escalation of Privileges Management System to submit a request to temporarily escalate or increase or elevate his privileges and/or to temporarily acquire new or additional or increased Roles and/or Permissions, for a particular reason or “justification”, and for particular time-period (e.g., 60 minutes); typically submitting a textual description that explain in a natural language (e.g., English) the reasons for the requested escalation, and optionally also describing which additional privileges are requested, or which privileges are requested to be increased or modified or elevated or escalated, and/or describing or naming which particular Role(s) and/or Permission(s) are requested by such user (e.g., the user is specifically requesting “TempAccessRoleDatabaseAdmin” for 60 minutes, or is requesting “TempAccessRoleNetworkAdmin” for 30 minutes, or is requesting “TempAccessRoleS3admin” for 45 minutes”); typically accompanied by a description or the reason or goal or justification (e.g., “to fix the database permissions for resolving Incident Ticket #12345”, or “to fix the network Access Control List (ACL) for resolving Support Ticket #76543”, or “to fix the S3 bucket for resolving Error Message #54321”, or “to restart a non-responding VM”, or the like).

The Applicant has realized that a senior system administrator at an organization may receive dozens, or even hundreds, of such Requests for Escalation of Privileges (REPs) per day. The Applicant has realized that properly understanding and handling such REPs is often time-consuming and error-prone. For example, realized the Applicant, the requesting team-member may not properly describe the problem that he is trying to resolve, or its level of urgency, or the particular reason for which Escalation of Privileges is requested. Additionally or alternatively, realized the Applicant, the requesting team-member may sometimes not indicate at all which particular privileges exactly he requests to escalate (e.g., since he composed the REP under time pressure), or may request an Escalation of Privileges beyond the minimum set of privileges that are actually required to achieve the goal or to resolve the problem. Additionally or alternatively, realized the Applicant, the requesting team-member may not know exactly which particular privileges he may or may not need, and/or which other or additional or related privileges he may further need in order to resolve the problem or achieve the goal. Additionally or alternatively, realized the Applicant, the system administrator or the other team-member who reviews the REP, may not fully or properly understand the REP, or the goal that the requesting user attempts to achieve, or the problem that the requesting user attempts to solve. Additionally or alternatively, realized the Applicant, the requesting team-member and/or the reviewing team-member may not be experts in the particular field of the problem (to be resolved) or the goal (to be achieved), and one of them or both of them may not fully or properly understand which privileged should or should not be escalated or granted in order to solve the problem or achieve the goal. Additionally or alternatively, realized the Applicant, even if the reviewing team-member receives all the relevant and correct information, the review and analysis of the information is still time-consuming and effort-consuming, and is also error-prone; particularly if dozens or even hundreds of such incoming REPs are sent per day or per week.

Additionally or alternatively, realized the Applicant, the requesting team-member should only the minimal permissions that are indeed required in order to complete his task, based on the “least privilege” principle); however, due to the number of roles and their variety, as well as the fine granularity of such roles, it may be difficult for the requesting team-member (and/or to the reviewing team-member) to properly understand what is the minimal set of privileges that should be granted or escalated or increased or modified or added, as well as which other privileges should not be granted or added or increased. Additionally or alternatively, realized the Applicant, may such REPs are composed and sent under a time-pressure or when an urgent problem arises, and are also reviewed and evaluated by the reviewing team-member under a similar time-pressure, making the correct and accurate evaluation even more difficult. Additionally or alternatively, realized the Applicant, human evaluation of, and response to, such REPs may cause other types of problems; for example, granting to a requesting team-member an escalated privilege that he does not actually need in order to resolve the problem or to achieve the goal; or, not granted to the requesting team-member an additional privilege that he did not explicitly request but that a correct evaluation of the problem or the goal would indicate as an additional privilege that is required; or, having “stale permissions” or “leftover privileges” that were granted to various team-members for solving a particular problem and that remained in place, sometimes days or weeks after the problem was resolved, thereby creating security risks, privacy risks, data leakage risks, and other risks.

The Applicant has realized the conventional system fail to address these problems. The Applicant has realized that conventional systems provide, at most, an interface that allows a requesting user to manually compose and submit a REP, which is then routed to a reviewing user who manually evaluates the REP and then manually approves (e.g., by clicking on a “Request Approved” on-screen button) that the system would proceed to change the privileges; the human evaluation of such ERP is often time-consuming/effort-consuming/error prone, and sometimes the reviewing user may err in the type or scope of privileges that are granted or are denied, and sometimes the system may leave behind “stale permissions” or “leftover privileges” long after the problem was solved or the goal was achieved.

Some embodiments of the present invention provide system and methods for automated handling of such Requests for Escalation of Privileges (REPs), using an automated system that utilizes Artificial Intelligence (AI)/Machine Learning (ML)/Deep Learning (DL)/Neural Network (NN), and particularly utilizing a Large Language Model (LLM) that is provided with relevant information and context for LLM-based or AI-based evaluation of such incoming REPs. In some embodiments, the LLM-based/AI-based system can automatically and autonomously evaluate an incoming REP, and may generate as output a suggested or proposed or recommended route of action that a reviewing user can then review and confirm or reject. The output generated by the LLM-based/AI-based system may include particular operational directives that enumerate, for example: (a) which particular privileges that the Requesting User requested, should be escalated, and to which level exactly; and/or, (b) which particular privileges that the Requesting User requested, should not be escalated; and/or (c) which particular privileges that the Requesting User did not request, should also be granted or escalated, and to which level exactly (e.g., because they are estimated/expected to be required in order to resolve the problem or achieve the goal); and/or (d) which additional modification/increase/reduction/granting/removal of privileges should be performed; and/or (e) what is the minimal set of privileges that are estimated/expected to be required in order to resolve the problem or achieve the goal; and/or (f) for which time-period (e.g., one hour; six hours; 12 hours; 24 hours) should the privileges (or some of them, or one of them) be granted or escalated; and/or (g) optionally, which other or additional privileges should be granted or escalated, on a temporary basis, to other users in the organization other than the Requesting User himself (e.g., by estimating that in order for the Requesting User to perform Task A, it is needed that User C would firstly perform Task B, and thus temporarily escalating or increasing the privileges of User C to be able to perform Task B); and/or (h) optionally, an indication of the estimated damage or risk or adverse consequences, that may result from non-granting of certain escalated privileges (e.g., “the company's website will be offline and the company will lose a million dollar of sales per day”) or from granting of certain privileges (e.g., “the granting of an Erase All privilege to User D, puts a risk that User D would erase, intentionally or mistakenly, an entire database table”); and/or (i) other outputs that can be generated by such LLM-based/AI-based evaluation system and can be useful or helpful for the Reviewing User in making the final decision about each REP.

In some embodiments, optionally, the LLM-based/AI-based evaluation system may optionally generate also: machine-readable code or code-portion or script or commands, that-if fed to the relevant unit or computer, after their approval by the Reviewing User-would cause the system to automatically perform the escalation/modification of privileges as proposed by the LLM-based/AI-based evaluation system. In some embodiments, optionally, the LLM-based/AI-based evaluation system may further be configured to automatically approve and automatically trigger/invoke/launch/perform a particular type of privilege escalations, without any human review or human evaluation, based on pre-defined rules and/or based on an LLM-based/AI-based evaluation that such automatic escalation would be non-risky or low-risk and would entail high-benefit to the organization or would prevent significant damage or adverse consequences. In some embodiments, optionally, such output generated by the LLM-based/AI-based evaluation system may further include code-portions or commands or machine-readable instructions that would cause automatic de-escalation or reduction or resetting of particular privileges at a particular future time-point (e.g., on Date D at time T), or after H hours or N days from the escalation of privileges, or if one or more other conditions hold true.

In accordance with some embodiments, a Role-Based Access Control (RBAC) system defines various Roles for different team-members or users. A Role is a set of abilities/capabilities/permissions/privileges that are given or assigned to that user, with regard to one or more organizational resources (servers, repositories, databases, disks, folders, documents, files, virtual machines, virtualized entities), or a collection of such permissions that lists the actions that are permitted to be performed by that user.

In accordance with some embodiments, a “Pre-Defined Role” (or a Regular Role, or a Default Role, or a Non-Escalated Role) is a Role defined by the system as having a set of permissions that are required to perform a specific task/action/operation or with regard to a specific resource. In accordance with some embodiments, a “Custom Role” (or a Modified Role, or an Escalated Role, or an Ad-Hoc Role) is created if the Pre-Defined Roles do not meet the specific needs of an organization or are not optimal for performing or completing a particular task or action; wherein a Custom Role is a collection of permissions that are typically defined by the system's users and not by the system owner.

In accordance with some embodiments, a Role is a collection of permissions; and a system that supports Custom Roles allows to create a new Role having a particular set or collection of permissions, which may typically be different from an existing Role in that system. In some RBAC systems, a conventional Role may include a large number of permissions associated with it. In particular, realized the Applicant, once a particular resource needs to be modified in a particular way (such that a “Read Only” permission is not sufficient), the regular Roles in some RBAC systems provide an excessive number of permissions than those that are actually required to achieve the task. In a demonstrative example, User Adam needs to restart a Virtual Machine (VM); the minimal Role for this task in the Microsoft Azure platform would be a Role that also permits the user to delete the VM, which is an excess permission that is not required for merely restarting the VM. In another example, User Bob may typically have Role #1 for completing his tasks; and in the escalation period, User Bob is granted an additional Role #2, which is temporarily assigned to User Bob in addition to his Role #1 that continues to regularly exist. In another example, User Carl may be assigned, in some embodiments, a Custom Role based on the minimal actions that he needs to perform and based on the minimal permissions that are required to perform those actions, such as “RoleRestartVM” that would permit to User Carl only to restart the VM and not to delete the VM; such Custom Role may not exist at all as a pre-defined role, and needs to be created ad hoc for this particular purpose, as a custom role; such as, by assigning the Azure permission of “Microsoft. ClassicCompute/virtualMachines/restart/action” to this newly-created Custom Role; thus avoiding an allocation of a Pre-Defined Role to User Carl, that would give to User Carl excessive permissions that are not required for completing the task at hand.

Some embodiments enable automatic and automated determination of the minimal permissions/lowest privileges that are necessary or required, in a situation where a Custom Role can be created, and/or in a situation where a Custom Role cannot be created (e.g., the computerized system that defines and manages user privileges supports only Pre-Defined Roles and does not support Custom Roles).

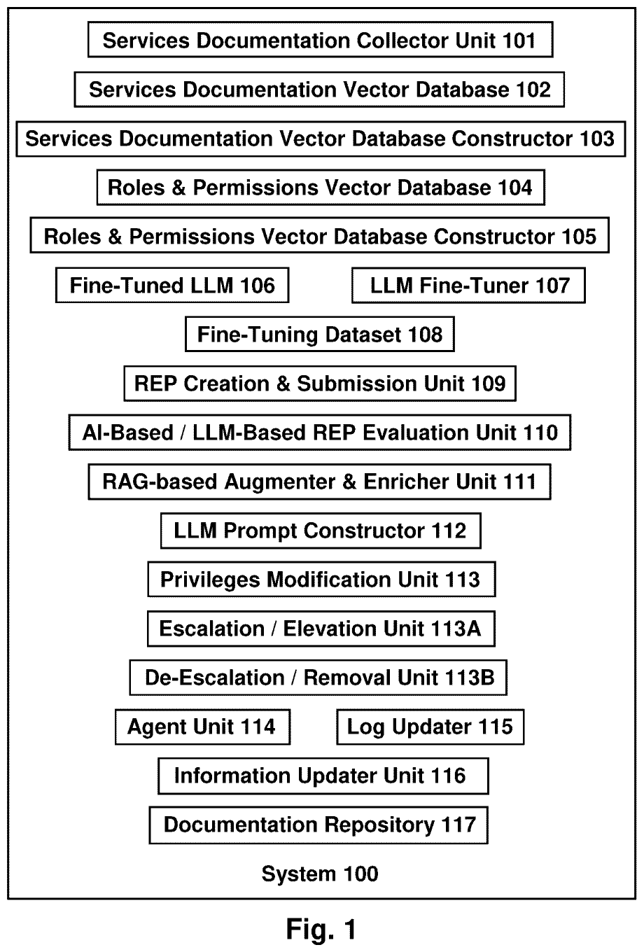

Reference is made to FIG. 1, which is a schematic block-diagram illustration of a system 100, configured to perform AI-based/LLM-based evaluation of Requests for Escalation of Privileges (REPs), in accordance with some demonstrative embodiments. The system may perform the following computerized method, using suitable hardware components and/or software components.

In Step 1 of the method, a vector database is constructed, containing the documentation of various services and/or resources and/or organizational resources and/or third-party resources (or cloud-based resources) that the organization utilizes. Such documentation may include, for example, user manual, troubleshooting guide, specification, white-paper, help files, glossaries, textual description of such resources and/or services, or the like. For some services or resources, such as Microsoft Azure cloud-based services, or Amazing Web Services (AWS) or Google Cloud Platform (GCP), such documentation is publicly available, and a Services Documentation Collector Unit 101 may obtain or fetch or download or copy such documentations, from publicly available resources and/or from the Internet and/or from relevant or pre-defined websites and/or from in-company documentation repositories. A Services Documentation Vector Database 102 is constructed by a Services Documentation Vector Database Constructor 103.

In accordance with some embodiments, raw documentation items collected by the Services Documentation Collector Unit 101 may be stored in a Documentation Repository 117; and an Information Updater Unit 116 may further operate to dynamically and/or continuously and/or periodically (e.g., every hour, every day, every week) update the contents of that Documentation Repository 117 to ensure that it stores and reflects the most updated version of each such documentation item. For example, the Information Updater Unit 116 may fetch or re-fetch (or may download or re-download) documentation items, as such documentations items may change over time by the entity that controls them (e.g., the cloud service provider). Optionally, the Information Updater Unit 116 may actively check whether a new version of a documentation item was published; and may replace a previous version of that documentation item in the Documentation Repository 117. In some embodiments, for example, the Information Updater Unit 116 may automatically deduce that a newer version was published or was downloaded, based on a file-name or a header or a heading or a title or meta-data of the downloaded documentation item; such as, triggering the Information Updater Unit 116 to replace a previous document named “Virtual-Machine-Whitepaper-Version-1.3.pdf” with the fresher version “Virtual-Machine-Whitepaper-Version-1.4.pdf”. Optionally, the Information Updater Unit 116 may utilize a document comparison unit to detect such updates or changes; or may utilize a set of pre-defined rules and conditions to detect such updates or changes (e.g., rules that specifically search for, and compare, version numbers or release-date numbers of documents); or may optionally utilize a Large Language Model (LLM) to determine which of two (or more) versions of documents is a newer one, or to determine whether Document A is a replacement version that entirely replaces Document B (e.g., the LLM may deduce this by noticing a comment inside Document B that states that “This document replaces Document A which is now obsolete”). In some embodiments, the Information Updater Unit 116 may further actively trigger the Services Documentation Vector Database Constructor 103 to re-construct or modify or update the Services Documentation Vector Database 102, in view of the replacement of an older version of a document with a newer version thereof, and/or in view of the addition of previous document(s) from the Documentation Repository 117, and/or the removal of obsolete/canceled/replaced documentation items from the Documentation Repository 117.

In step 2 of the method, a Roles & Permissions Vector Database 104 is constructed by a Roles & Permissions Vector Database Constructor 105, containing all the Roles and Permissions, with a textual description of each permission. For example, a demonstrative Pre-Defined Role can be represented as follows, based on a Microsoft Azure role:

### Role Name: “Virtual Machine Contributor”

Role Description: “Create and manage virtual machines, manage disks, install and run software, reset password of the root user of the virtual machine using VM extensions, and manage local user accounts using VM extensions. This role does not grant you management access to the virtual network or storage account the virtual machines are connected to. This role does not allow you to assign roles in Azure RBAC”.

Role Permissions: this may include a variety of particular Permissions; and for each such Permission, the data may include: (I) a Permission Indicator (or Permission Identifier), such as, “Microsoft.Compute/virtualMachines/restart/action; and (II) an associated Permission Description, such as, “Restarts the virtual machine”.

In step 3 of the method, a Large Language Model 106 (e.g., Llama-2, Mistral) is fine-tuned by an LLM Fine-Tuner 107. The fine-tuning includes modification of weights and biases, based on a Fine-Tuning Dataset 108 of documents. Each document in the Fine-Tuning Dataset 108 may include: (i) a textual description of an input scenario (e.g., a task that the Requesting User needs to perform, or a problem that the Requesting User needs to solve); and (ii) an output that describes the lowest role and/or the minimal permissions that are needed to perform the task/to solve the problem. The output may be one of several possible types; for example: (a) if Custom Roles are supported, then the output is the minimal list of permissions that can be granted to achieve performance of the task; (b) if Custom Roles are not supported, then the output is the minimal list of Pre-Defined Roles that that can be granted to achieve performance of the task. In both situations (namely, if Custom Roles are supported, or if Custom Roles are not supported), then the output may further include: (c) a textual explanation in a natural language (e.g., English) that describes each Permission, and why exactly it is needed or required in order to achieve completion of the task or in order to solve the problem.

In step 4 of the method, a team-member or user composes and submits a Request for Escalation of Privileges (REP), using a REP Creation & Submission Unit 108. The REP is routed to an AI-Based/LLM-Based REP Evaluation Unit 110, which performs/controls/orchestrates the automated evaluation of the REP.

For example, for an incoming REP received from a Requesting User, a RAG-Based Augmenter & Enricher Unit 111 utilizes Retrieval Augmented Generation (RAG) to augment and enrich the content of the REP and to construct an augmented and enriched prompt (or query) that would be later fed to the LLM. The RAG-based augmentation and enrichment includes the relevant documentation (or document-portions or document-segments) from the Services Documentation Vector Database 102, such as document-segments that have semantic similarity (to the REP content) that is greater than a pre-defined similarity threshold value. Optionally, the Prompt Augmenter & Enricher Unit 111 performs further augmentation or enrichment by utilizing the Roles & Permissions Vector Database 104.

It is noteworthy that, as realized by the Applicant, it is not feasible and/or it is not efficient to feed into the LLM, in a single prompt or even in a chain or series of several prompts, “all” the available documentation that relate to all available services/applications/CSP systems/computerized processes/threats and risks; as such enormous-size prompt (which can span millions or even billions of words or tokens) is not supported by a typical LLM (as each LLM has a prompt size-limit; such as, Meta Llama2 has a token limit of 4,096 tokens; OpenAI GPT-4 has a token limit of 32,768; Claude 2.1 has a token limit of 200,000, which is still much smaller than the size of “all documentation” which can span many terabytes of text), and/or since an enormous size of prompt (that includes, for example, thousands or millions of documentation articles and whitepapers) may cause the LLM to perform slowly and/or inadequately and to generate incorrect or “hallucinated” output(s). Rather, in accordance with some embodiments, RAG and Semantic Similarity are utilized to select particular documentations items, and particular segments or portions of such selected documentation items, to create a concise prompt that contains only relevant documentation-segments and examples.

Then, an LLM Prompt Constructor 112 constructs the actual prompt that will be fed to the LLM, taking into account whether or not this particular RBAC system supports Custom Roles. If Custom Roles are supported, then the LLM Prompt Constructor 112 constructs a prompt that commands the LLM to produce a list of minimal Permissions that would achieve the task (or, would solve the problem) described in the REP. Conversely, if Custom Roles are not supported, then the LLM Prompt Constructor 112 constructs a prompt that commands the LLM to produce a list of minimal Pre-Defined Roles that would achieve the task (or, would solve the problem) described in the REP.

In step 5 of the method, the prompt as constructed by the LLM Prompt Constructor 112 is fed or inputted into the fine-tuned LLM 106, which generates an output indicating the LLM-based evaluation of the REP. In accordance with some embodiments, such LLM-based evaluation output from the LLM 106, as well as the original REP, are sent to a Reviewing User for approval/rejection/modification. In some embodiments, optionally, the LLM may be specifically prompted or commanded, in advance and via the machine-constructed prompt, to explain the need or the necessity for each and every Permission or Pre-Defined Role. Such explanation(s) may be provided by the LLM to the Requesting User at one or more time-points: for example, the original prompt that is constructed and fed to the LLM, may already include a command to the LLM to convey in its evaluation results the particular Justification/Reasoning for each permission or role that it proposes to assign to the Requesting User; and, additionally or alternatively, in some embodiments, the system may enable the Reviewing User to submit back a prompt or a query, that would be fed back to the LLM, requesting clarifications with regard to the necessity for a particular role or permission, or with regard to the justification or reasoning behind the particular escalation proposal that was generated by the LLM, and even enabling the Reviewing User to submit clarification questions such as “Why does the system propose Role A and not Role B” or “Why is it necessary to assign Permission X to this user in order to restart the VM” or “Will the user be able to perform VM Deletion if he is assigned Role B”, or other questions that would allow the Reviewing User to obtain back from the LLM more clarity and confidence in order to evaluate the LLM's proposal.

In some embodiments, optionally, the LLM may be specifically prompted or commanded to describe in its output, which Permissions or Pre-Defined Roles that were requested by the Requesting User should indeed be approved; and/or which other which Permissions or Pre-Defined Roles that were requested by the Requesting User should indeed be denied; and optionally an explanation for each such approval or denial.

In some embodiments, a Reviewing User then reviews the LLM-based evaluation output (with the original REP); and utilizes a Privileges Modification Unit 113 to invoke the privileges modifications that such Reviewing User approves.

In Step 6 of the method, in accordance with some embodiments, if the REP is approved, and the system supports Custom Roles, then: the LLM is prompted to generate the information to perform an Application Programming Interface (API) call to create the Custom Role (e.g., a JSON code-portion with the required data), and an Agent Unit 114 (an applicative layer) performs the API call according to the LLM-generated information. It is clarified that the description of the API call is generated by the LLM; and the actual invocation of the API called is performed by the Agent Unit 114. Accordingly, the Privileges Modification Unit 113 gives the particular Permissions to the Requesting User. Additionally, in some implementations, the Custom Role will be automatically removed/deleted/discarded from the system, using a second API call that is performed by the Agent Unit 114 based on the LLM-generated output, to prevent “stale permissions” or “leftover privileges”. Conversely, if the system does not support Custom Roles, then a similar flow is performed by assigning one or more Pre-Defined Roles to the Requesting User; similarly via a first API call that the Agent Unit 114 performs based on the LLM-generated output, followed later by a second API call that removes or de-assigning those Pre-Defined Roles from the Requesting User after a pre-defined time period. In some embodiments, removal or discarding or cancelation of the Custom Role or the added Pre-Defined Roles, may be performed automatically by the Agent Unit 114, after a pre-defined time-period elapses as suggested in the LLM-generated output; and/or (in some implementations, as an optional feature) if the Agent Unit 114 detects that one or more conditions hold true (e.g., a web server that previously returned a 500 Error is now responsive; a web-page that previously returned a 404 Error is now responsive).

In accordance with some embodiments, a Log Updater 115 operates to create and update a log or Audit Log(s) that track and reflect modifications of Permissions, creation and cancelation of Custom Roles, assigning and de-assigning of Pre-Defined Roles, and/or other such changes. Optionally, notification messages may be generated and sent to the Requesting User and/or the Reviewing User and/or other users (e.g., a system administrator; a security team) with regard to such modifications, and/or indicating the status of each REP (e.g., approved; rejected; approved for H hours; partially approved and partially rejected; or the like).

In some embodiments, optionally, the LLM may further be commanded, as part of the prompt that is fed to the LLM for each REP being evaluated, to further generate additional/optional outputs, such as: (a) an LLM-generated output that describes the estimated risk or damage or adverse consequences that the LLM estimates to exist due to approval of the REP and/or due to escalation of the privileges of the Requesting User; and/or (b) an LLM-generated output that describes the estimated damage or adverse consequences that the LLM estimates as possibly occurring if the requested escalation/modification of privileges would not be approved or performed; and/or (c) an LLM-generated output that describes the actual level of urgency that the LLM estimates to be associated with the REP being evaluated (e.g., most Requesting Users may indicate that their REPs are “Urgent”; yet the LLM may opine that a REP for restarting a web server in production is Very Urgent, whereas a REP for restarting a testing device is Not Urgent). The LLM may be prompted, automatically by using one or more prompts selected from a pool of additional prompts, to generated such or other advice with regard to each REP; and such additional LLM-generated output(s) may further assist the Reviewing User in reaching his final decision regarding each REP.

In a first demonstrative example, system 100 handles an incoming REP in a configuration that does not support creation of Custom Roles. For example, the Requesting User submits the following REP: “I am an on-call developer; I received an alert that a queue in Microsoft Azure Queues is full, and that the service that writes to the queue has crashed; I need permission to restart the Virtual Machine (VM) on which this service is running on, and to purge the queue”.

In that first demonstrative example, the LLM-based evaluation of the REP, utilizing the fine-tuned LLM and optionally further taking into account additional context (e.g., enriched/augmented prompt), generates the following output (which begins with the words “In order” and ends with the word “running”):

“In order to achieve the goal, the user would need to have at least two Pre-Defined Roles, which are:
Pre-Defined Role 1: Storage Queue Data Contributor;
Pre-Defined Role 2: Virtual Machine Contributor.

Here is an explanation that can help the Reviewing User understand why these two Pre-Defined Roles are necessary: (a) The Pre-Defined Role of ‘Storage Queue Data Contributor” is needed to enable the user to interact with the Microsoft Azure Queue storage, and provides the user with the ability to read, write, and delete messages in Microsoft Azure Storage queues, and in this specific case, it would enable the user to purge the queue when that queue is full; (b) The Pre-Defined Role of ‘Virtual Machine Contributor’ is needed to enable the user to manage virtual machines (VMs) in Microsoft Azure, and provides the user with permission to restart the virtual machine, and in this specific case it would enable the user to restart the virtual machine where the service that writes to the queue is running.”

The above-mentioned LLM-based output can greatly assist the Reviewing User in his final evaluation/approval/denial of the REP in that first demonstrative example.

In a second demonstrative example, system 100 handles an incoming REP in a configuration that supports creation of Custom Roles. For example, the Requesting User submits the following REP: “I am an on-call developer; I received an alert that a queue in Microsoft Azure Queues is full, and that the service that writes to the queue has crashed; I need permission to restart the Virtual Machine (VM) on which this service is running on, and to purge the queue”.

In that second demonstrative example, the LLM-based evaluation of the REP, utilizing the fine-tuned LLM and optionally further taking into account additional context (e.g., enriched/augmented prompt), generates the following output (which begins with the words “In order” and ends with the word “running”):

“In order to achieve the goal, the user would need to have at least two particular Permissions:
Permission 1: Microsoft.Storage/storageAccounts/queueServices/queues/messages/delete
Permission 2: Microsoft.ClassicCompute/virtualMachines/restart/action.

Here is an explanation that can help the Reviewing User understand why these two Permissions are necessary. Permission 1 is needed to interact with the Azure Queue storage. It provides the user with the ability to delete messages in Azure Storage queues. In this case, it allows the user to purge the queue when it's full. Permission 2 is necessary to manage virtual machines (VMs) in Azure. It provides the user with permission to restart the VM. In this case, it allows the user to restart the VM where the service that writes to the queue is running”.

The above-mentioned LLM-based output can greatly assist the Reviewing User in his final evaluation/approval/denial of the REP in that second demonstrative example.

It is noted that in systems that support Custom Roles, the selective and ad hoc automated choosing of particular Permissions that are determined by the LLM to be necessary to achieve the goal, and the creation of such minimalist Custom Role with only those Permissions and without adding any other Permission that is not strictly necessary to achieve that goal, is a preferred approach; in order to ensure strict or stricter compliance with the Principle of Least Privileges (PoLP); and a creation of such Custom Role that includes only that minimal set of Permissions is thus preferred over assigning or adding to the Requesting User a Pre-Defined Role that includes excessive Permission(s) that are not strictly necessary to achieve that goal.

In each of the above-mentioned examples, the LLM-based output may further include additional insights with regard to the REP, or with regard to consequences or risks that may occur if the REP is approved or denied; or with regard to the actual level of urgency that the LLM-based evaluation estimates to exist based on all the context that it received; or with regard to the time-period that the elevated permissions or the escalated privileges should be granted, or with a time-point at which such elevated permissions or the escalated privileges should be revoked or reset or canceled; or other LLM-generated insights that can further clarify the REP or that can otherwise assist the Reviewing User in deciding or acting on the REP. In some embodiments, optionally, the LLM-generated output may further include machine-readable code or code-portions that can then be read and executed by a computerized component or unit or module, to perform the temporary escalation or elevation of privileges and permissions, and/or to later cancel or terminate such escalation or elevation. For example, the Privileges Modification Unit 113 may include an Escalation/Elevation Unit 113A capable of performing such escalation/elevation of privileges or permissions (including, and not limited to, creation of a Custom Role with a particular set of one or more Permissions, and assigning the Custom Role to the Requesting User; or, assigning one or more Pre-Defined Roles to the Requesting User); as well as an automatic De-Escalation/Removal Unit 113B capable of terminating or discarding or resetting or canceling such escalation/elevation of privileges or permissions (including, and not limited to, canceling or deleting or discarding or de-assigning the Custom Role that as given to the Requesting User; or, de-assigning or canceling or removing or discarding one or more Pre-Defined Roles that were given to the Requesting User).

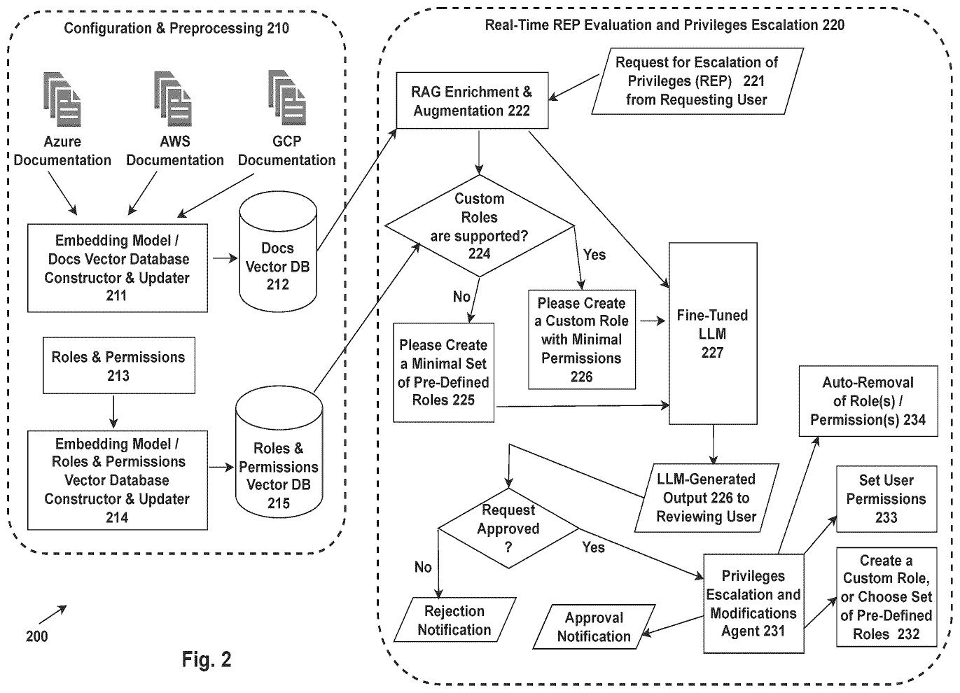

Reference is made to FIG. 2, which is a schematic block-diagram illustration of a system 200, configured to perform AI-based/LLM-based evaluation of Requests for Escalation of Privileges (REPs), in accordance with some demonstrative embodiments. System 200 of FIG. 2 may be a demonstrative implementation of System 100 of FIG. 1; or, System 100 of FIG. 1 may be a demonstrative implementation of System 200 of FIG. 2; or, components and/or operations from the two systems (100, 200) may be otherwise combined or co-implemented as a single system.

A Configuration and Processing Sub-System 210 operates to collect data and to construct (and subsequently also: to dynamically update, continuously or periodically) the relevant Vector Databases. For example, Azure Documentation, AWS documentation, GCP documentation, and other types of documentation items (e.g., Microsoft Windows documentation; Linux documentation; MacOS documentation; documentation about web browsers such as Chrome and Firefox; documentation about particular applications such as remote access applications; driver documentation; Operating System(s) documentations) are collected or downloaded or obtained from internal/external/organizational resources and/or from the Internet; and an Embedding Model operates as a Documentation Vector Database Constructor and Updater 211, to construct (and later also update) the Documentation Vector Database 212. Similarly, data about Roles and Permissions 213 is collected, and an Embedding Model operates as a Roles & Permissions Vector Database Constructor and Updater 214, to construct (and later also update) the Roles & Permissions Vector Database 215.

A Real-Time REP Evaluation and Privileges Escalation sub-system 220 operates upon receiving a REP 221 from a Requesting User. RAG enrichment and augmentation (block 222) are performed on the REP, utilizing also data from the Documentation Vector Database 212. The enriched and augmented REP is fed as input to a Fine-Tuned LLM 227, which also receives as input either: (i) an indication that the system supports Custom Roles, or (ii) an indication that the system does not support Custom Roles. It is clarified that such indication need not be a manual indication from the Requesting User or from the Reviewing User or from any other human; rather, in some implementations, such indication (of whether or not the current system supports Custom Roles) may be pre-configured in a particular system, or may be a binary flag or parameter that a system administrator can set in advance or when the system is implemented or deployed, or may be an indication that the system can obtain or deduce by itself from publicly-available documentation or from a configuration file. For example, the system checks (block 224) whether or not Custom Roles are supported, based on data from the Roles & Permissions Vector Database 215 or from publicly-available documentation or from a configuration file or from other sources. If Custom Roles are supported, then the Fine-Tuned LLM 227 will receive as an additional input or as additional context the indication that Custom Roles are supported, and/or an indication that the Fine-Tuned LLM 227 should create a Custom Role having the minimal permissions that are needed to achieve the goal (or to solve the problem) indicated in the REP (block 226). Conversely, if Custom Roles are not supported, then then the Fine-Tuned LLM 227 will receive as an additional input or as additional context the indication that Custom Roles are not supported, and/or an indication that the Fine-Tuned LLM 227 should create a minimal set of Pre-Defined Roles (block 225) needed to achieve the goal (or to solve the problem) indicated in the REP.

The fine-tuned LLM 227 receives the output of the RAG enrichment and augmentation, as well as the indication whether Custom Roles or only Pre-Defined Roles are supported; and performs LLM analysis and processing of those inputs, and generates output (block 226) that includes the minimum Role(s)/Permission(s) that are needed to achieve the goal (or to solve the problem), and that further include textual explanations of why each such permission/role is needed.

The LLM-generated output is transferred to the review by a Reviewing User, who may approve or reject the LLM-based proposal that was generated in response to the REP. In some embodiments, optionally, a chat or chat-like interface or other messaging interface may be implemented, to enable the Reviewing User to pose one or more clarification questions about the LLM-based proposal and/or about the Justification/Reasoning/Necessity for each Role/Permission, or about other aspects of the REP or of the LLM-based proposal (e.g., “will Role A give the user a permission to do action B”; or “why is Permission C needed to achieve Goal D”; or the like); and such questions from the Reviewing User are automatically routed back to the LLM, and LLM-generated responses or feedback are then transferred back to the Reviewing User. Optionally, in some implementations, the Reviewing User may even have the capability to command the LLM, via such messaging interface, to modify the initial LLM-based proposal or to fine-tune it and to provide an updated/modified LLM-based proposal; such as, the Reviewing User may optionally convey back to the LLM, via such chat or messaging system, a command of “Please modify or update your LLM-based proposal such that User A will not have a permission to delete a VM”, or “Please modify or update your LLM-based proposal such that User B will have a permission only to create a new record in Database D and will not have permission to delete or modify an existing record in Database D”; and such additional commands or guidelines from the Reviewing User are automatically routed back to the LLM, which in turn generates accordingly an updated/modified proposal.

If the Reviewing User rejects the LLM-generated proposal (which may be a single or original proposal; or may be an updated or modified version thereof after such additional commands), then a REP rejection notification is sent to the Requesting User. Conversely, if the Reviewing User approves the LLM-generated proposal, then a Privileges Escalation & Modifications Agent Unit 231 is triggered to perform the relevant escalation operations based on the LLM-generated output, for example: (a) to create the Custom Role or the set of Pre-Defined Roles (block 232), (b) to send a REP approval notification to the Requesting User, (c) to set or modify the user permissions (block 233), and (d) subsequently, to automatically remove/discard/cancel/reset the elevated permissions or roles or privileges (e.g., after a pre-defined time-period elapses, and/or after a proposed time-period elapses as indicated in the LLM-generated output).

Some embodiments of the present invention may optionally provide one or more of the following benefits or advantages. (A) Automated Minimal Permission Determination, and compliance with the Principle of Least Privileges (PoLP), by introducing an automated method for determining the minimal set of permissions required for a user to perform a specific task within a role-based access control system, leveraging a fine-tuned LLM to interpret natural language task descriptions or requests; and providing a solution to the need to perform a rapid and accurate evaluation a REP, which can often have a high degree of urgency (e.g., a production server or a production database is “down” or is offline, and the organization is losing thousands of dollars per minute from lost transactions). (B) Retrieval-Augmented Generation for Contextual Relevance, employing RAG to enhance or enrich or augment the context of user requests with semantically relevant or semantically similar documentation-segments that a RAG unit selects from a comprehensive vector database; obviating the need to provide to the LLM an enormous body-of-knowledge as part of the prompt, and enabling to use concise and focused prompts that keep the token count low and that can assist in preventing LLM “hallucination” errors; and ensuring that the determination of permissions is both accurate and aligned with the specific requirements of the task. (C) Dynamic Custom and Pre-Defined Role Management, enabling the system to dynamically decide whether to create custom roles with minimal permissions or to select the most appropriate pre-defined roles based on the capabilities of the role-based access control system, offering flexibility and precision in permission granting; in contrast with conventional systems, which typically do not enable the user to request custom roles with such fine-grained actions duo the complexity and amount of actions. (D) Optionally, as an optional feature in some advanced implementations of particular organizations who choose to do so, an Automated (or semi-automated, or partially-automated) Approval and Role Lifecycle Management, thus automating and facilitating the approval process for permission requests, including the generation of necessary API calls for the creation and removal of custom roles, thereby streamlining the process of temporary permission escalation. (E) Multi-Language Support for Global Accessibility, enabling a Requesting User to write in any natural language that is supported by the LLM (e.g., French, Spanish), thus enabling automatic handling of REPs in a variety of natural languages, facilitated by the LLM's ability to translate and process non-English descriptions, and thus enhancing its accessibility to users worldwide of the same organization, and even enabling the Reviewing User to obtain LLM-generated outputs in a first language (e.g. English) when the REP was actually composed in a second, different, language. (F) Security and Compliance Auditing, since a Log is maintained and updated and can be used for auditing the usage of granted permissions against the specified tasks, ensuring compliance with the least privilege principle and also providing a mechanism to detect and respond to potential misuse or security risks. (G) Dynamic/Continuous/Periodical Database Updating, such that the system's vector databases are dynamically updated with the latest documentation on services, roles, and permissions; thereby ensuring that the decision-making process for permission granting remains up-to-date with the evolving landscape of cloud services and access control policies. (H) User Interface for Request Submission and for Request Review/Approval/Rejection, utilizing a user-friendly interface that allows users to easily submit their REPs in natural language, to simplify the process of requesting escalation of privileges, and thus also lowering the barrier to entry for users that are unfamiliar with the complexities of role-based access control systems. (I) Detailed Logging and Reporting for transparency/compliance/auditing, providing to administrators visibility into the history of permission requests and approvals, modifications and escalations and de-escalations; thereby assisting in audits, compliance checks, understanding the decision-making process, enhancing trust in the system's operations, debugging of error or bugs, or otherwise reviewing the history of modifications and their reasons. (J), Optionally, a Feedback Mechanism may enable continuous improvement, using a feedback loop from Requesting Users and/or from Reviewing Users, thereby enabling the system to refine and improve over time based on direct input regarding the adequacy and efficiency of the permissions granted; with a user-driven improvement cycle that ensures the system evolves to meet the changing needs and expectations of its user-base.

In some embodiments, the system may include or may utilize a variety of components, some of them are shown in FIG. 1 and/or FIG. 2, and some of them listed herein: (a) Natural Language Processing (NLP) unit, which may assist one or more other components of the system in processing REPs submitted in natural language, facilitating the initial input of task descriptions for permission analysis and/or improving or augmenting or enriching prompts. (b) Vector Database of Service Documentation, which stores and indexes comprehensive documentation from various service providers and/or cloud-based providers, enabling efficient retrieval of relevant information for permission determination. (c) Roles and Permissions Database and/or Index, representing a A detailed catalog of predefined roles and/or possible custom roles along with their associated permissions, serving as a reference during the permission mapping process and/or the construction of new custom roles and/or the selection of particular pre-defined roles and/or the selection of particular permissions. (d) Fine-Tuned LLM, which analyzes task descriptions to predict or deduce or estimate or determine the minimal set of permissions and/or roles needed, leveraging training on task-permission datasets. (e) Retrieval-Augmented Generation (RAG) Unit or RAG engine, which enhances or enriches or augments user requests with semantically relevant documentation-segments from the vector database to provide enriched/augmented context for the LLM's analysis. (f) Custom Role Generator, which dynamically creates custom roles with a minimal permission set when custom roles are supported by the RBAC system. (g) Pre-Defined Role Selector, which dynamically identifies or selects the minimal set of pre-defined roles that would be sufficient for the user's task when custom roles are not supported. (h) Automated Approval Workflow Manager, which manages the process of submitting a REP by a Requesting User, and for reviewing by a Requesting User such submitted REP accompanied by its LLM-based evaluation results. (i) An API Call Constructor, which generates or constructs the specific API calls that is utilize to create or revoke custom roles within the access control system based on approved permissions. (j) Temporary Permission Assigner, which assigns the approved permissions or roles to the Requesting User for a limited time-period, ensuring that access is granted only as long as needed, and automatically canceling or revoking or discarding or de-assigning the elevated permissions once that time-period elapses. (k) Role Revocation Mechanism, which automatically removes or deletes or discards or revokes the assigned custom roles or revokes permissions once the task is completed or after a predetermined time. (l) Optionally, a Multi-Language Support Unit, enabling to process REPs in a variety of natural languages, translating them as needed for universal accessibility. (m) Security and Compliance Auditor Unit, which tracks and audits the use of granted permissions and/or assigned roles and/or created custom roles, ensuring they are used appropriately for the specified tasks, and optionally further configured to detect abuse or misuse or out-of-scope use. (n) User Interface generators for providing a UI or GUI for submitting REPs and for reviewing/approving/rejecting the LLM-based proposals for actions for such REPs. (o) Optionally, a Feedback Loop or a Machine Learning (ML) Feedback Loop, which can learns from past decisions on REPs to improve the accuracy and efficiency of future predictions and approvals, optionally as an additional layer that can be added before or after the LLM-based evaluation of each new REP. (p) Notification and Alert System, which informs users and system owners about the status of REPs, including approvals, rejections, role assignments, custom role creations, expiration of custom roles, termination of elevated privileges, and/or other events. (q) Logging and Reporting Dashboard, which maintains and provides detailed logs and reports on REPs, approvals, rejections, and the rationale behind decisions, enhancing transparency and compliance. (r) Optionally, a Feedback Collection Interface which can gather feedback from Requesting Users and/or from Reviewing Users, about the system's performance and the adequacy of granted permissions or roles, thereby enabling a feedback loop that can be used in a manual process or in an automated/Machine Learning process to improve the system's efficiency and/or accuracy. (s) Dynamic Database Updater, which regularly/continuously/periodically (e.g., daily, weekly) updates the documentation vector database and the roles & permissions vector database (or index, or catalog) with new or updated information from cloud providers and service providers, and optionally also based on particular user feedback (e.g., reflecting a particular knowledge-base of the organization or a third party with regard to a particular task or service or process). (t) Access Control System Integrator, which can interface with the underlying role-based access control (RBAC) system to implement the permission and role assignments/modifications/elevation/revocations. (u) Document Semantic Analysis Unit, which analyzes services documentation to identify and index the semantic meanings, facilitating the retrieval of contextually relevant information for permissions mapping, and optionally utilized for RAG enrichment and augmentation of prompts for the fine-tuned LLM. (v) Task-Permission Mapping Unit, which can utilize outputs from the fine-tuned LLM to map natural language task descriptions to specific permissions or roles, thereby enhancing the precision of permissions granted, and optionally enabling re-utilization of such mapped correlations in subsequent events, by the fine-tuned LLM itself and/or by the RAG unit and/or by a manual reviewer that may wish to consult with such already-mapped correlation data. (w) Cloud Service API Interface, which enables communication with cloud providers' APIs for fetching the latest services, documentation files, roles data and permissions data, to keep the vector database(s) current and up-to-date. (x) User Role Management Dashboard, which may be a centralized interface for system administrators to view and manage user roles, REPs, and the exact status of current and historical requests. (y) Data Privacy and Security unit or layer, which ensures that all user data and REPs are handled in compliance with data protection regulations, thereby safeguarding sensitive information. (z) Optionally, as an optional component in some advanced implementations, an Adaptive Learning unit or algorithm, which can adjust the system's predictive model based on feedback and/or outcomes, ensuring continuous improvement in the accuracy of permission and role assignments; for example, using a Machine Learning (ML) unit or Deep Learning (ML) unit or other learning unit to detect that Reviewing User James repeatedly asks, when he gets an LLM-based proposal, a particular type of question (e.g., “Does this proposal permit the Requesting User to delete a table from a database”), and thus ensuring that future LLM-based proposals are generated to already include in them a response to such repeating question, or that such a repeating question is provided in advance to the LLM as an additional portion of the prompt to ensure that the LLM-generated proposal complies with a requirement that is conveyed in such repeating question; or to otherwise improve the process that generates LLM-based proposals, based on previous sessions or previous user feedback.

Some embodiments may operate to solve or eliminate or mitigate one or more problems that conventional systems may have, for example: (a) Complexity in Determining Minimal Permissions; the problem being, correctly and efficiently identifying the least privilege set of permissions that is necessary for a task, which is a challenging task due to the complexity and granularity of permissions in role-based access control systems; and the solution being, a system that employs a fine-tuned LLM to analyze natural language descriptions of tasks or problems or REPs, automatically determining via LLM-based processing the minimal set of permissions needed, simplifying the decision-making process. (b) Delay in Permission Approval Processes; the problem being that traditional permission approval processes are often slow, creating bottlenecks that hinder prompt access to necessary resources, especially in urgent scenarios; and the solution being, a method for automating the REP evaluation and REP approval workflow, which streamlines the permission request and approval process, significantly reducing the time required to grant (or deny) elevated privileges. (c) Risk of Over-Privileged Access; the problem being that manually assigning permissions can lead to over-privileged access, thus increasing security risks and the potential for data breaches; and the solution being a system that ensures that only the minimal necessary permissions are granted for specific tasks, thereby minimizing the risk of over-privileged access and enhancing security. (d) Inefficiency in Role Management; the problem being that managing custom and pre-defined roles can be time-consuming and effort-consuming and error-prone or otherwise inefficient, with significant manual effort required to create and revoke roles; the solution being a system that automates (or, at least partially automates) the creation and revocation of custom roles based on the task's requirements, improving efficiency in role management. (e) Language Barriers in Global Organizations; the problem being that non-English speakers may face challenges in requesting permissions due to language barriers, limiting their access to necessary resources; and the solution being a system that may optionally provide: With multi-language support, which can process requests in various natural languages, making it accessible to a global user-base and reducing language barriers. (f) Lack of Real-Time Documentation Updates; the problem being a difficulty for decision makers or Reviewing Users/Requesting Users to keep up with the latest changes in cloud services and their associated permissions or roles, leading to outdated access control decisions; and the solution being the utilization of a dynamic database updater that ensures that the vector databases are regularly/periodically/continuously updated with the latest documentation, keeping the system current and accurate. (g) Difficulty in Auditing and Compliance; the problem being that tracking and auditing permission use can be challenging, complicating compliance with internal and external regulations or work procedures; and the solution being a system with a security and compliance auditor component or Log Updater that tracks the granted permissions and their actual use, facilitating easier auditing and compliance with security policies. (h) Manual Feedback and Improvement Processes; the problem being collecting and implementing feedback on access control processes, which is often manual and slow and inefficient, hindering continuous improvement; and the solution being an optional feedback collection interface, enabling automatic collection and integration of feedback to continually refine and improve the system. (i) Inadequate Transparency in Permission Decisions; the problem being that system administrators and/or users may lack insight into the rationale behind REP decisions, sometimes leading to confusion and mistrust or leading to inconsistency among different reviewers that review similar REPs and reach different results; and the solution being an automated system that uses LLM-based analysis of REPs for reaching more-accurate decisions and consistent decisions, as well as a logging and reporting unit that can provide detailed insights into permission requests, approvals/rejections, and the rationale associated with them. (j) User Interface and System Complexity; the problem being that some traditional systems often feature complex user interfaces for permission requests, creating a barrier for users that are unfamiliar with access control specifics; and the solution being an innovative system with a user-friendly interface for submitting REPs and for reviewing REPs and acting on them, which simplifies the process and enables users to submit tasks in a natural language, making the system more accessible and reducing errors.

In some embodiments, the Fine-Tuning process of the LLM may optionally include one or more procedures designed to tailor the model's capabilities to accurately predict or estimate or deduce the minimal set of permissions or roles that are required for achieving specific tasks that are described by a Requesting User in a REP composed in a natural language. The fine-tuning process is important for enhancing the LLM's understanding and interpretation of complex, task-specific requirements within the context of role-based access control (RBAC) systems. The fine-tuning process can involve one or more steps, optionally also leveraging a combination of Machine Learning techniques, comprehensive datasets, and iterative refinement to achieve optimal performance. For example, the fine-tuning of the LLM may include one or more of the following procedures. (a) Data Collection and Preparation: The foundation of the fine-tuning process begins with the collection and preparation of a diverse dataset that comprises descriptions of a wide range of tasks alongside the corresponding minimal permissions or roles necessary to perform those tasks. This dataset may be derived from real-world scenarios, expert inputs, and documentation from various cloud services and/or RBAC systems, ensuring a comprehensive representation of potential user requests. Each entry in the dataset is annotated, linking natural language task descriptions with the exact permissions or predefined roles required, providing a clear target for the LLM to learn from. (b) Pre-processing and Normalization: Once collected, the dataset undergoes pre-processing and normalization to ensure consistency and compatibility with the LLM's training process. This may involve, for example, converting the permissions and roles into a standardized format, cleaning and normalizing the natural language descriptions, and optionally translating entries from multiple languages into English to maintain uniformity. Tokenization, lemmatization, and the removal of irrelevant information can also be part of this stage, preparing the data for efficient learning. (c) Initial Model Selection and Configuration, by selecting the appropriate base LLM for fine-tuning. The chosen model should have a robust pre-existing understanding of natural language, and should capable of adapting to the specific nuances of RBAC terminology and concepts. The configuration of the model, including the adjustment of hyper-parameters such as learning rate, batch size, and the number of training epochs, can be tailored to balance the trade-off between learning speed and the risk of over-fitting. (d) The particular Fine-Tuning Process itself, executed through a series of training cycles where the model is exposed to the prepared dataset. During each fine-tuning cycle, the LLM processes the task descriptions, attempting to predict the corresponding permissions or roles. The predictions are then compared to the actual annotations in the dataset, with discrepancies informing the adjustments made to the model's parameters. The fine-tuning process can employ a loss function specifically designed to penalize inaccuracies in the prediction of permissions, thereby guiding the model towards more precise outputs. (e) Validation and Iterative Refinement: in parallel to the training cycles or after them, a validation process can be conducted using a separate portion of the dataset that was not exposed to the model during training. This validation can evaluate the model's accuracy and generalization capabilities on unseen data. Based on the performance metrics obtained during validation, further refinements can be made to the model's configuration and training approach. Optionally, an iterative process of training, validation, and refinement may continue, until the model demonstrates a high level of accuracy and reliability in correctly predicting/deducing/estimating minimal permissions or roles across a variety of task descriptions. (f) Integration and Continuous Learning: once it is fine-tuned, the LLM can be integrated into the broader system, where its LLM-generated predictions or insights are used inform the automated permission determination and approval units or processes. Optionally, a feedback loop and/or a continuous learning mechanism can be implemented, allowing the model to further adapt and improve over time based on user feedback and/or based on new data. This can include the incorporation of user feedback, outcomes of permission requests, and fresh updates to cloud services and RBAC systems and their relevant documentations, ensuring that the model remains accurate and effective even as Access Control needs and practices are evolving or changing over time. In some embodiments, the fine-tuning process of the LLM can contribute to the system's precision, efficiency, and adaptability in managing permissions within a variety of RBAC systems; ensuring that a Requesting User is granted the minimal necessary permissions to perform his task, thereby enhancing security while facilitating operational efficiency.

In some embodiments, optionally, an additional process can be used, collecting and providing Organizational Context and/or other relevant contexts to the fine-tuned LLM as part of its mission to automatically evaluate REPs from Requesting Users. Such additional context, and particularly Organizational Context, can be provided to the system or to the LLM in one or more suitable ways; for example, the Organizational Context may be provided by the RAG unit, by way of enriching or enhancing or augmenting the prompt, such as, by adding to the prompt the organizational context of “This REP was sent by User Adam, whose position in the organization is Junior Tester, and who started working at the organization two weeks ago”, and optionally also further context of “Please comply the policy of this organization that dictates that an employee who is wither the organization less than 90 days will not receive a Write permission to any Production server or database”; or in contrast, additional Organizational Context indicating that “This REP was submitted by the CTO of this organization, who works here for 12 years and supervises 450 developers”; or other data about the Requesting User and its experience/job title/job description/responsibilities/expertise/department, as such additional information may be useful for the LLM in evaluating the REP. In some embodiments, optionally, the LLM may even be fine-tuned on a dataset that reflects particular examples, which may be similar to the above-mentioned examples, to steer the LLM towards such organizational policy or to otherwise train or fine-tune the LLM towards particular directions in evaluating REPs. Such additional/organizational context may ensure that the system's outputs are not only accurate but also optimally aligned with the specific needs and nuances of an organization's access control policies, and/or in compliance with particular procedures or laws or regulations that characterize a particular organization in a particular field (e.g., healthcare; banking). The process may utilize various key stages, ranging from data collection and contextualization to integration and continuous adaptation, ensuring that the fine-tuned LLM can generate the most appropriate permissions or roles for any given REP and its task request. Such procedure for providing additional context may include, for example, the following steps. (a) Data Collection and Contextualization: extensive collection of data that reflects the organizational structure, existing roles and permissions, and specific access control policies. This data can be sourced from various organizational documents, including policy manuals, access control lists, role definitions, and previous permission request logs. The goal is to create a comprehensive picture of how permissions are structured and managed within this specific organization, as well as to understand the typical workflows that necessitate permission requests. To enrich this data with context, each piece of information can be tagged with metadata that describes its relevance to different parts of the organization, such as departments, positions, roles, or specific applications and services. This contextualization can enable the LLM to make distinctions between similar requests coming from different parts or departments of the organization, which may require different handling due to varying policies or security requirements. For example, the same REP may be treated differently, when it arrives from a Junior Quality Assurance Tester, or from a Senior Production Developer; and such context may be useful for the LLM-based evaluations. (b) Integration of Organizational Context into the LLM: once the data is collected and contextualized, the system may integrate such organizational context into the LLM; such as, by embedding the contextual data into the model's training dataset, and/or by adjusting the model's architecture/biases/weights to incorporate context as an input parameter alongside the natural language REP task descriptions. Embedding the context into the training dataset can be done by annotating the natural language descriptions of tasks with the relevant organizational context, ensuring that the model can learn the nuances of how permissions are granted within different parts of the organization. This may include, for example, tagging of tasks with department-specific identifiers, or noting when a particular role has unique access requirements. In some embodiments, to incorporate context as an input parameter, the model's architecture can be adjusted to accept and process such additional input; allowing the LLM to tailor its predictions based on the provided context, enhancing the relevance and accuracy of the permissions or roles that the LLM then suggests. (c) Dynamic Contextualization for Optimal Outputs: further to the initial integration of organizational context, and in order to ensure optimal outputs from the LLM, dynamic contextualization can be employed. This involves, for example, continuously updating the contextual data provided to the model to reflect changes within the organization, such as restructuring, policy updates, or the introduction of new services and roles. The dynamic contextualization can optionally be supported by a feedback loop that captures outcomes of permission requests, including approvals, rejections, and any modifications made during the approval process. The feedback can be analyzed to identify patterns or discrepancies that may indicate the need for adjustments in the contextual data or its application within the model. (d) Continuous Learning and Adaptation: optionally, as another component of providing organizational context to the LLM, a continuous learning mechanism can be used to allow the model to adapt over time. As the model processes permission requests and receives feedback, it learns to better understand the implications of the organizational context on permission decisions. This learning can optionally be facilitated by regular/periodical re-training sessions where the model is updated with new data and contextual insights, ensuring that its predictions remain aligned with the organization's evolving access control landscape. In some embodiments, such detailed process of collecting, integrating, and dynamically updating Organizational Context, the system can ensure that the LLM can generate outputs that are not only accurate but also aligned with the specific operational and security needs of the organization. This approach can enhance the efficiency and security of the permission granting process, ensuring that users have the access level that they need to perform their tasks without compromising the organization's access control policies or the specific limits that are defined for specific positions or departments within the organization. It is noted that the above-mentioned features of providing Organizational Context, via LLM fine-tuning and/or by RAG enriching and RAG augmenting of the prompts to the LLM, is an optional process that can be implemented in some embodiments if desired by the organization; for example, indicating to the LLM whether the REP was submitted by a newly-hired Junior Tester, or conversely from a veteran Senior Production Engineer, as a non-limiting demonstrative example. Additionally, each organization may have its own Policies with regard to who can (or cannot) be assigned particular permissions, and the LLM can be made aware of such Policies and take them into account; for example, since Organization A may have a rule that “Junior Tester will Never have a Write Access to a Production Server, under any circumstances”, and the LLM should comply with such policy once it is conveyed to the LLM. In some embodiments, such additional yet optional organizational context may further be used by the LLM to estimate/predict/quantify the risk or the adverse consequences or the potential damage that may occur if the REP is approved, or conversely if the REP is denied; for example, taking into account that a freshly-hired junior tester has a greater potential to cause damage to organizational resources relative to an experienced senior developer

In some embodiments, optionally, JSON or other technologies can be used to implement one or more features of the system. For example, the flexible and human-readable format of JSON can be utilized to define permissions and roles within the system. Each permission or role can be represented as a JSON object, containing key-value pairs that detail the scope, actions, and any conditions or limitations associated with it. The structured representation allows for easy handling, storage, and retrieval of permissions data, thereby facilitating the dynamic creation and management of custom roles based on specific task requirements. Furthermore, JSON can be used for storing task descriptions and optionally mappings; for example, to store natural language task descriptions alongside their corresponding permissions or roles mappings. By encapsulating these mappings in JSON format, the system can efficiently organize and access the necessary data to train the LLM and to make accurate permission predictions for incoming requests. Additionally, JSON can be used to configure the system settings, including the parameters for the LLM, the settings for the retrieval-augmented generation (RAG) unit, and other system parameters.

In some embodiments, optionally, API calls or REST calls or HTTP(S) calls or other technologies can be used to implement one or more features of the system. For example, API calls or other calls can enable efficient and smooth integration with external RBAC systems, cloud services, and other organizational resources or computerized infrastructure. Through API calls or other types of calls, the system can dynamically retrieve information about existing roles and permissions, submit requests for creating or revoking custom roles, and manage or modify or revoke or elevate user permissions in real-time or in near-real-time; ensuring that system's decisions are actionable (immediately after their approval by the human Reviewer User), thereby enhancing operational efficiency. Similarly, API calls can be used regularly by the system for retrieving and updating documentation; by accessing the latest documentation from cloud providers and other services, which is important for keeping the vector database current. By automating the retrieval and updating of this documentation, the system ensures that its permission predictions are always based on the most up-to-date information, maintaining its accuracy over time, and adapting to ongoing changes in various cloud services or other services as they occur from time to time.

Some embodiments may optionally generate one or more LLM-based outputs that are innovative, each one by itself and/or as a combination, and/or that conventional systems did not generate. Such innovative outputs can include one or more of the following. (a) Minimal Permission Set, as the LLM generates a concise list of the minimal permissions required for a user to complete a specific task, ensuring adherence to the principle of least privilege within the RBAC framework. (b) Custom Role Definitions; for systems supporting custom roles, the LLM outputs detailed definitions for custom roles, including necessary permissions tailored to the user's task, optimizing access control by creating roles that match exact requirements. (c) Pre-Defined Role Recommendations; where custom roles are not supported, the LLM recommends a selected set of pre-defined roles within the organization's RBAC system that closely match the task's requirements, helping users quickly gain the access they really need. (d) Explanations for Permissions; the LLM provides textual explanations detailing why each permission or role is necessary for the task, enhancing understanding and transparency in the permission granting process, and facilitating auditing and compliance review. (e) API Call Specifications; for the automation of role creation and management/modification/revocation/resetting, the LLM generates specifications for API calls, optionally including the necessary endpoints and payload structures (e.g., in JSON format), facilitating seamless integration with access control systems via an Agent Unit. (f) Security and Compliance Reports can be innovatively produced by the system or by its LLM, highlighting potential security or compliance issues related to the requested permissions, and/or offering insights into any risks associated with granting the requested access. (g) Feedback Requests can optionally be generated, as structured requests for feedback on the adequacy and effectiveness of the permissions granted, in order to gather input as an optional feedback loop from Requesting Users and Reviewing Users to enable continuous improvement of the system. (h) Audit Logs that can be kept by the system, documenting the permission request process, including decisions made, roles assigned, and the rationale behind these decisions, supporting transparency and accountability. (i) Permission Revocation Lists, as part of managing temporary access, indicating a list of currently-active permissions or roles that should be revoked (or that are scheduled/planned to be revoked) after a task is completed or after a certain time-period elapses, ensuring that the elevated access is only temporary. (j) Task-Specific Documentation References, wherein the LLM can identify and can optionally also output references to specific segments of documentation that are relevant to the Requesting User's, providing additional context and resources to help users understand the permissions or roles that were granted; particularly if the actually-granted permissions are slightly different or entirely different from those that were originally requested in the REP.

Some embodiments may provide systems and methods for automated minimal permission assignment; for example, a method for automatically determining and assigning the minimal set of permissions required by a user to perform a specific task within a role-based access control system. The method may include: constructing (and then updating) a vector database containing documentation of services and roles with their permissions; fine-tuning an LLM model on documents that describe tasks and corresponding minimal permissions or roles needed; using retrieval-augmented generation to enrich and augment user requests with relevant documentation portions/segments/excerpts; determining whether custom roles are supported and, based on that, generating a list of minimal permissions or pre-defined roles needed for the task; facilitating the approval process for the requested permissions or roles; and generally managing the lifecycle of custom roles or applying pre-defined roles as necessary. Some embodiments utilize RAG enrichment of REPs, to enhance the process of identifying the minimal set of permissions or roles needed for a task by augmenting user requests with semantically similar documentation from a vector database.

Some embodiments enable automated Custom Role creation and management in a role-based access control system, by generating necessary information for API calls to create and remove custom roles based on approved permissions, and assigning these roles to users for a limited duration. Some embodiments provide smart and efficient selection and utilization of Pre-Defined Role, by selecting the minimal set or minimal combination of pre-defined roles to meet user requests for permissions, including the identification of the minimal set of pre-defined roles that fulfill the requirements of a specified task when custom roles are not supported.

Some embodiments provide an automated or semi-automated Review and Approval Process for REPs or other Permission Escalation Requests; by providing to the Reviewing User an output of insights generated by the fine-tuned LLM, indicating the REP as well as an LLM-proposed minimal set of permissions or roles along with a textual explanation or reasoning of their necessity for the task.

Some embodiments may utilize LLM fine-tuning for Task-Specific Permissions; for example, by fine-tuning the LLM on a dataset of documents that describe tasks alongside their minimal necessary permissions or roles, to accurately predict and explain the minimal permissions required for new tasks that need to be evaluated. Some embodiments further provide dynamic permission assignment based on task requirements, either through the creation of custom roles or by selection of pre-defined roles, and subsequently revoking or canceling or resetting or discarding such elevated/assigned/escalated permissions upon task completion or after a pre-defined time-period elapses.

Some embodiments provide a Notification System for role assignment and revocation, capable of notifying system administrators and/or users about the status of permission escalation requests, including approvals, rejections, role assignments, creation of custom roles, and revocations, thereby ensuring transparency and accountability and providing an audit trail. Some embodiments further provide or utilize API Integration for role management, by optionally integrating with external APIs to manage the lifecycle of custom roles, including creation and deletion/revocation, based on the LLM-proposed and human-approved minimal set of permissions, ensuring that users are granted only the necessary access and only for a limited time.

Some embodiments provide documentation and semantic analysis for assisting the LLM in permissions determination; by building and utilizing a vector database of services documentation as well as roles/permissions documentation, and by performing semantic similarity analysis to match user-submitted tasks or REPs with the most relevant documentation segments, thereby facilitating the accurate LLM-based determination of minimal permissions or roles. Some embodiments thus provide a system for automatically handling and evaluating permission escalation requests using a large language models, retrieval-augmented generation, and a detailed process for both custom and pre-defined roles within a role-based access control system.

Some embodiments provide a method for automatically determining and granting minimal necessary permissions to a user for performing a specified task within a role-based access control (RBAC) system. The method may comprise: Building a vector database of service documentation and roles with permissions; Utilizing a fine-tuned LLM to interpret natural language descriptions of tasks to identify required permissions; Employing retrieval-augmented generation (RAG) to augment task descriptions with semantically relevant documentation segments from the vector database; Determining the minimal set of permissions or roles, whether custom or pre-defined, necessary for the task based on LLM analysis; Facilitating an automated approval and assignment process for the determined permissions or roles.

In some embodiments, the vector database includes documentation from multiple cloud providers and services, ensuring comprehensive coverage of services and permissions. Some embodiments further comprise the step of fine-tuning the LLM on a dataset comprising pairs of natural language task descriptions and corresponding minimal permissions or roles, to enhance the accuracy of prediction of the minimal set of required permissions for a given task or REP. In some embodiments, the retrieval-augmented generation (RAG) employs a semantic similarity measure to retrieve documentation segments that most closely match the user's task description or REP content, enriching the context for LLM analysis. In some embodiments, the determination of whether custom roles are supported is based on the capabilities or features of the specific RBAC system, with the method dynamically and automatically adapting to either generate a custom role with a minimal permission set or select the minimal necessary pre-defined roles. In some embodiments, the method includes automatically generating API call information for the creation and removal/revocation of custom roles, based on the human-approved LLM-generated minimal permissions set, when custom roles are supported. In some embodiments, the approval process includes the provision of an LLM-generated textual or verbal explanation alongside the minimal set of permissions or roles, detailing the necessity of each permission for the completion of the task to which the REP pertains.

Some embodiments further provide a notification mechanism, to inform both the requester and the reviewer/owner/administrator of the status of the permission escalation request, including approval or rejection, and optionally also including tracking information that indicates whether elevated permissions or assigned roles are still active or were revoked/canceled. In some embodiments, the assignment of permissions or roles to the user is temporary, with a “watchdog” unit or mechanism in place for the automatic revocation of said permissions or roles upon completion of the specified task or after a predetermined time-period. In some embodiments, the method integrates with external APIs for the creation/management/revocation of roles within the RBAC system, facilitating the automated creation, assignment, and revocation of custom roles.

In some embodiments, the vector database is dynamically/continuously/periodically updated to include new services, roles, and permissions as they become available from cloud providers or other sources, ensuring that the permission determination process remains accurate and current. Some embodiments may further provide a UI or GUI to enable a Requesting User to input his REP or task description in a natural language, simplifying the process of requesting permissions or roles. Optionally, the LLM may be capable of handling requests in multiple natural languages, making the system accessible to a global user base by translating non-English task descriptions into English for processing and vice versa for the output; and enabling a Requesting User to compose his REP in a first natural language, whereas a few seconds later, the Reviewing User received the LLM-generated proposal output in a second, different, natural language.

Some embodiments may optionally utilize also a Machine Learning unit or algorithm, to learn from past approval decisions, thereby improving the efficiency and accuracy of future permission predictions and approval processes. Some embodiments may further include a security and auditing unit, which can audit the use of granted permissions or roles, tracking their usage against the specified task to ensure compliance and detect potential misuse or abuse. The system provides detailed logging and reporting capabilities, allowing administrators to review the history of permission requests, approvals, and the rationale behind the determination of the minimal set of permissions or roles. Optionally, the system may provide a feedback mechanism that enables Requesting Users and/or Reviewing Users to rate the adequacy and efficiency of the granted permissions or roles, contributing to continuous improvement of the system through user input and via a feedback loop.

Some embodiments provide a computerized method for automatically evaluating requests for escalation of privileges in an organization. The computerized method comprises: (a) receiving a Request for Escalation of Privileges (REP), in a natural language, that indicates a request from a

Requesting User to elevate access privileges to a computerized organizational resource; (b) automatically feeding the REP as input into a fine-tuned Large Language Model (LLM); (c) automatically performing by said fine-tuned LLM an analysis of said REP, and automatically generating an LLM-based output indicating at least: a proposed minimal set of elevated permissions that are estimated by the LLM to be needed and also sufficient for achieving a task described in the REP.

In some embodiments, the method and/or step (c) further comprises: automatically generating said LLM-based output that further comprises a textual reasoning for inclusion of at least one elevated permission in said proposed minimal set of elevated permissions.

In some embodiments, the method and/or step (c) further comprises: automatically generating said LLM-based output that comprises at least one elevated permission that was not explicitly requested by said Requesting User in said REP, and that the fine-tuned LLM predicts to be necessary for achieving said task described in said REP.

In some embodiments, the method and/or step (c) further comprises: automatically generating said LLM-based output that comprises machine-readable code that, when executed by a machine, causes automatic granting of said elevated permissions to said Requesting User.

In some embodiments, the method and/or step (c) further comprises: automatically generating said LLM-based output that comprises machine-readable code that, when executed by said machine, causes automatic revocation of said elevated permissions after a pre-defined time-period elapses.

In some embodiments, the method and/or step (c) further includes: automatically generating said LLM-based output that further comprises: a textual LLM-generated explanation of one or more adverse consequences that the fine-tuned LLM estimates to occur if said proposed minimal set of elevated permissions is not approved.

In some embodiments, the method and/or step (c) further includes: automatically generating said LLM-based output that further comprises: a textual LLM-generated explanation of an estimated level of urgency that the fine-tuned LLM estimates to be associated with said task described in said REP.

In some embodiments, the method and/or step (c) further includes: automatically generating said LLM-based output that comprises definitions for automatic creation of a Custom

Role that includes exactly said proposed minimal set of elevated permissions and no additional permissions.

In some embodiments, the method and/or step (c) further comprises: automatically generating said LLM-based output that comprises definitions for automatic assignment of one or more pre-defined roles that together include exactly said proposed minimal set of elevated permissions and no additional permissions.

In some embodiments, the method and/or step (b) further comprises: feeding to said fine-tune LLM a signal indicating whether Custom Roles are supported or only Pre-Defined Roles are supported; if Custom Roles are supported, then the method comprises: automatically generating said LLM-based output that comprises definitions for automatic creation of a Custom Role that includes exactly said proposed minimal set of elevated permissions and no additional permissions; if Custom Roles are not supported and only Pre-Defined Roles are supported, then the method comprises: automatically generating said LLM-based output that comprises definitions for automatic assignment of one or more pre-defined roles that together include exactly said proposed minimal set of elevated permissions and no additional permissions.

In some embodiments, the method and/or step (b), of automatically feeding the REP as input into the fine-tuned LLM, comprises: (b1) enriching said REP by performing Retrieval Augmented Generation (RAG), and generating a RAG-enriched prompt; (b2) feeding said RAG-enriched prompt as input to the fine-tuned LLM.

In some embodiments, enriching said REP is performed using a RAG unit that has access to a vector database that was constructed with embeddings from a plurality of documentation items corresponding to a plurality of computerized services and cloud-based services.

In some embodiments, enriching said REP comprises: adding to said REP a context that includes selected segments of said documentation items that said RAG units determines to have semantic similarity to said REP beyond a pre-defined threshold level of semantic similarity.

In some embodiments, enriching said REP is performed using a RAG unit that has access to a vector database that was constructed with embeddings from data-sources describing roles and permissions in said organization.

In some embodiments, the method comprises: constructing said fine-tuned LLM by fine-tuning an already-existing LLM with an annotated dataset that includes: (i) textual natural-language descriptions of tasks that users would like to achieve, and (b) for each of said tasks, a list of minimal permissions that are required for completing said task.

In some embodiments, the method comprises: d) automatically revoking said elevated permissions, after elapsing of a pre-defined time-period that was indicated in said output of said fine-tuned LLM in response to said REP.

In some embodiments, the method comprises: (d1) automatically providing the output of said fine-tuned LLM, in response to said REP, to a computing device of a Reviewing User; (d2) receiving from said Reviewing User either an approval or a rejection of the proposal of minimal set of elevated permissions that was generated by said fine-tuned LLM; (d3) if in step (d2) an approval signal was received from the Reviewing User, then: automatically invoking the minimal set of elevated permissions that were indicated in the proposal generated by said fine-tuned LLM, and automatically sending a message to the Requesting User indicating which permissions were elevated; (d4) if in step (d2) a rejection signal was received from the Reviewing User, then: automatically sending a message to the Requesting User indicating that the REP was rejected.

In some embodiments, the method comprises: (d1) automatically providing the output of said fine-tuned LLM, in response to said REP, to a computing device of a Reviewing User; (d2) receiving from said Reviewing User one or more clarification questions, and feeding the one or more clarification questions based into said fine-tuned LLM; (d3) in response to the one or more clarification questions from the Reviewing User, generating by said fine-tuned LLM at least one of: (i) one or more responses to said one or more clarification questions, (ii) a modified output of minimal set of elevated permissions.

In some embodiments, the REP from the Requesting User is in a first natural language, and is processed by the fine-tuned LLM; and output from said fine-tuned LLM is provided to the Reviewing User in a second, different, natural language. In some embodiments, the system may utilize the LLM, or a natural language processing unit, to detect which natural language the REP is in; and/or to detect which other natural language is preferred by the Reviewing User (e.g., based on use-defined preferences or indications by the Reviewing User, or based on pre-defined system preferences that allow the REP to be in a variety of natural languages and that also require that the decision on the REP would be in a particular natural language such as English); and may optionally utilize a translation unit or an LLM-based translation function, to translate the REP from a first natural language to a second natural language in which the REP is then processed by the LLM, and such that the LLM output is generated directly in that second natural language; or conversely, to process the REP by the LLM in the original first natural language of the REP, and to generate LLM-based output in that first natural language, and to then translate that LLM-generated output to a second natural language for presenting the evaluation result to the Reviewing User in that second natural language. For example, the Requesting User may compose his REP in English; the REP may be analyzed in English by the LLM; and the LLM-generated output may be translated automatically from English to Spanish to be presented to a Spanish-preferring Reviewing User; or, the Requesting User may compose his REP in Spanish; the REP may be automatically translated to English, and then analyzed in English by the LLM; and the LLM-generated output may be generated in English to be presented to an English preferring Reviewing User; or, the Requesting User may compose his REP in Spanish; the REP may be analyzed in Spanish by the LLM; and the LLM-generated output may be generated in Spanish and then translated automatically from to English to be presented to an English-preferring Reviewing User; or by using other set of automated operations that enable the system to automatically handle REPs in any suitable natural language and/or to generate its evaluation results and/or escalation proposal in any (possibly other, different), natural language.

Some embodiments provide a non-transitory storage medium having stored thereon instructions that, when executed by a machine, cause the machine to perform a method as described above and/or herein.

Some embodiments provide a system comprising: one or more hardware processors, configured to execute code; associated with one or more memory units, configured to store data; wherein the one or more hardware processors are configured to perform an automated process or an automated method as described above and/or herein.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, GPUs, integrated circuits (ICs), logic gates, logic units, memory units, storage units, wireless communication modems or transmitters or receivers or transceivers, cellular transceivers, a power source, input units, output units, Operating System (OS), drivers, applications, and/or other suitable components.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, a Virtual Reality (VR) or Augmented Reality (AR) or Mixed Reality (MR) device or headset or gear, a “kiosk” type device or a vending machine or an Automatic Teller Machine (ATM), a laptop computer, a desktop computer, a vehicular computer or system, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Dart, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method for automatically evaluating requests for escalation of privileges in an organization, the computerized method comprising:
(a) receiving a Request for Escalation of Privileges (REP), in a natural language, that indicates a request from a Requesting User to elevate access privileges to a computerized organizational resource;
(b) automatically feeding the REP as input into a fine-tuned Large Language Model (LLM);
(c) automatically performing by said fine-tuned LLM an analysis of said REP, and automatically generating an LLM-based output indicating at least: a proposed minimal set of elevated permissions that are estimated by the LLM to be needed and also sufficient for achieving a task described in the REP.

2. The computerized method of claim 1,
wherein step (c) further comprises:
automatically generating said LLM-based output that further comprises a textual reasoning for inclusion of at least one elevated permission in said proposed minimal set of elevated permissions.

3. The computerized method of claim 1,
wherein step (c) further comprises:
automatically generating said LLM-based output that comprises at least one elevated permission that was not explicitly requested by said Requesting User in said REP, and that the fine-tuned LLM predicts to be necessary for achieving said task described in said REP.

4. The computerized method of claim 1,
wherein step (c) further comprises:
automatically generating said LLM-based output that comprises machine-readable code that, when executed by a machine, causes automatic granting of said elevated permissions to said Requesting User.

5. The computerized method of claim 4,
wherein step (c) further comprises:
automatically generating said LLM-based output that comprises machine-readable code that, when executed by said machine, causes automatic revocation of said elevated permissions after a pre-defined time-period elapses.

6. The computerized method of claim 1,
wherein step (c) further comprises:
automatically generating said LLM-based output that further comprises:
a textual LLM-generated explanation of one or more adverse consequences that the fine-tuned LLM estimates to occur if said proposed minimal set of elevated permissions is not approved.

7. The computerized method of claim 1,
wherein step (c) further comprises:
automatically generating said LLM-based output that further comprises:
a textual LLM-generated explanation of an estimated level of urgency that the fine-tuned LLM estimates to be associated with said task described in said REP.

8. The computerized method of claim 1,
wherein step (c) further comprises:
automatically generating said LLM-based output that comprises definitions for automatic creation of a Custom Role that includes exactly said proposed minimal set of elevated permissions and no additional permissions.

9. The computerized method of claim 1,
wherein step (c) further comprises:
automatically generating said LLM-based output that comprises definitions for automatic assignment of one or more pre-defined roles that together include exactly said proposed minimal set of elevated permissions and no additional permissions.

10. The computerized method of claim 1,
wherein step (b) further comprises:
feeding to said fine-tune LLM a signal indicating whether Custom Roles are supported or only Pre-Defined Roles are supported;
if Custom Roles are supported, then the method comprises: automatically generating said LLM-based output that comprises definitions for automatic creation of a Custom Role that includes exactly said proposed minimal set of elevated permissions and no additional permissions;
if Custom Roles are not supported and only Pre-Defined Roles are supported, then the method comprises: automatically generating said LLM-based output that comprises definitions for automatic assignment of one or more pre-defined roles that together include exactly said proposed minimal set of elevated permissions and no additional permissions.

11. The computerized method of claim 1,
wherein step (b), of automatically feeding the REP as input into the fine-tuned LLM, comprises:
(b1) enriching said REP by performing Retrieval Augmented Generation (RAG), and generating a RAG-enriched prompt;
(b2) feeding said RAG-enriched prompt as input to the fine-tuned LLM.

12. The computerized method of claim 11,
wherein enriching said REP is performed using a RAG unit that has access to a vector database that was constructed with embeddings from a plurality of documentation items corresponding to a plurality of computerized services and cloud-based services.

13. The computerized method of claim 12,
wherein enriching said REP comprises: adding to said REP a context that includes selected segments of said documentation items that said RAG units determines to have semantic similarity to said REP beyond a pre-defined threshold level of semantic similarity.

14. The computerized method of claim 12,
wherein enriching said REP is performed using a RAG unit that has access to a vector database that was constructed with embeddings from data-sources describing roles and permissions in said organization.

15. The computerized method of claim 1, further comprising:
constructing said fine-tuned LLM by fine-tuning an already-existing LLM with an annotated dataset that includes: (i) textual natural-language descriptions of tasks that users would like to achieve, and (b) for each of said tasks, a list of minimal permissions that are required for completing said task.

16. The computerized method of claim 1, further comprising:
(d) automatically revoking said elevated permissions, after elapsing of a pre-defined time-period that was indicated in said output of said fine-tuned LLM in response to said REP.

17. The computerized method of claim 1, further comprising:
(d1) automatically providing the output of said fine-tuned LLM, in response to said REP, to a computing device of a Reviewing User;
(d2) receiving from said Reviewing User either an approval or a rejection of the proposal of minimal set of elevated permissions that was generated by said fine-tuned LLM;
(d3) if in step (d2) an approval signal was received from the Reviewing User, then:
automatically invoking the minimal set of elevated permissions that were indicated in the proposal generated by said fine-tuned LLM, and automatically sending a message to the Requesting User indicating which permissions were elevated;
(d4) if in step (d2) a rejection signal was received from the Reviewing User, then:
automatically sending a message to the Requesting User indicating that the REP was rejected.

18. The computerized method of claim 1, further comprising:
(d1) automatically providing the output of said fine-tuned LLM, in response to said REP, to a computing device of a Reviewing User;
(d2) receiving from said Reviewing User one or more clarification questions, and feeding the one or more clarification questions based into said fine-tuned LLM;
(d3) in response to the one or more clarification questions from the Reviewing User, generating by said fine-tuned LLM at least one of: (i) one or more responses to said one or more clarification questions, (ii) a modified output of minimal set of elevated permissions.

19. The computerized method of claim 1,
wherein the REP from the Requesting User is in a first natural language,
and is processed by the fine-tuned LLM,
and wherein output from said fine-tuned LLM is provided to the Reviewing User in a second, different, natural language.

20. A system comprising:
one or more hardware processors, that are configured to execute code,
and that are operably associated with one or more memory units that are configured to store code;
wherein the one or more hardware processors are configured to perform a computerized process for automatically evaluating requests for escalation of privileges in an organization,
the computerized process comprising:
(a) receiving a Request for Escalation of Privileges (REP), in a natural language, that indicates a request from a Requesting User to elevate access privileges to a computerized organizational resource;
(b) automatically feeding the REP as input into a fine-tuned Large Language Model (LLM);
(c) automatically performing by said fine-tuned LLM an analysis of said REP, and automatically generating an LLM-based output indicating at least: a proposed minimal set of elevated permissions that are estimated by the LLM to be needed and also sufficient for achieving a task described in the REP.

21. A non-transitory storage medium having stored thereon instructions that, when executed by a machine, cause the machine to perform a method for automatically evaluating requests for escalation of privileges in an organization, the method comprising:
(a) receiving a Request for Escalation of Privileges (REP), in a natural language, that indicates a request from a Requesting User to elevate access privileges to a computerized organizational resource;
(b) automatically feeding the REP as input into a fine-tuned Large Language Model (LLM);
(c) automatically performing by said fine-tuned LLM an analysis of said REP, and automatically generating an LLM-based output indicating at least: a proposed minimal set of elevated permissions that are estimated by the LLM to be needed and also sufficient for achieving a task described in the REP.
